(19) United States
(12) Patent Application Publication
(10) Pub. No.: US 2006/0196607 A1
(43) Pub. Date: Sep. 7, 2006

(54) Plastic welding machine

(75) Inventors: Wilfried Halfmann, Kaiserslautern (DE); Bern Maue, Kreimbach-Kaulbach (DE); Achim Kretschmann, Winnweiler (DE); Manfred Neurohr, Kaiserslautern (DE)

Correspondence Address: MCGLEW & TUTTLE, PC, P.O. BOX 9227, SCARBOROUGH STATION, SCARBOROUGH, NY, 10510-9227, US

(73) Assignee: PFAFF INDUSTRIES MASCHINEN AG, Kaiserslautern (DE)

(21) Appl. No.: 10/562,624

(22) PCT Filed: Jun. 21, 2004
(86) PCT No.: PCT/EP04/06677

§ 371 Date: Dec. 23, 2005

(30) Foreign Application Priority Data
Jun. 25, 2003 (DE) 103 28 498.2

(51) Int. Cl. B32B 37/00; B32B 38/00; B32B 41/00

(52) U.S. Cl. 156/359; 156/378; 156/499; 156/538

(57) ABSTRACT

A plastic welding machine, especially a hot air or hot wedge sealing machine, for connecting in a material fit at least two layers (38, 39; 43, 44; 48-50). The welding machine (1) comprises welding tools (7), at least one pair of driving rollers (8, 9) each, and an electronic control device (2) including a computer (3) for controlling the temperature of the welding tools (7) and for adjusting and regulating the pressure of the driving rollers (8, 9). A welding machine is provided wherein the welding process can be sequence-controlled substantially independently of the respective operator of the welding machine (1). For this purpose, the sequence control of the welding process is carried out without intervention of the operator only using a sequence program (welding program) stored in a memory (35) of the electronic control device (2). The entire area to be sealed of the two layers (38, 39; 43, 44; 48-50) is divided up into a plurality of welding sections (40-42; 45-47; 52-54) before the welding process is carried out. The (primary) welding parameters to be kept for every welding section (38, 39; 43, 44; 48-50), such as the temperature of the welding tool (7) or the welding medium, the rate of feed of the two or one of the two driving rollers (8, 9), the driving roller pressure, etc. are determined. The parameters corresponding to these adjustments are stored in a data memory (36) of the control device (2) to which the sequence control program gains access.

### CROSS REFERENCE TO RELATED APPLICATIONS

This application is a United States National Phase application of International Application PCT/EP2004/006677 and claims the benefit of priority under 35 U.S.C. §119 of German Application DE 103 28 498.2 filed Jun. 21, 2001, the entire contents of which are incorporated herein by reference.

### FIELD OF THE INVENTION

The present invention pertains to a plastic welding machine, especially a hot air or heating wedge welding machine, for the connection in substance of at least two layers, wherein the welding machine has welding tools, at least one pair of drive rollers each as well as an electronic control device comprising a computer for controlling the temperature of the welding tools and for setting and regulating the pressure of the drive rollers.

### BACKGROUND OF THE INVENTION

Such a welding machine is known essentially already from DE 198 54 259 C2. This is a hot sealing machine, in which two layers connected by a sewn seam are subsequently sealed by welding on a strip. In this prior-art welding machine, an electronic control device monitors all the preset, relevant welding parameters in order to ensure a certain quality of the weld seam.

However, the process control proper is performed in the prior-art welding device by a human operator during the welding operation (e.g., by actuating a pedal). Therefore, if, for example, two layers are to be connected to one another, which contain a curved section, the particular human operator changes the welding parameters when the curved section is reached by changing the position of the pedal, so that the velocity of feed of the two drive rollers is reduced and, e.g., the temperature of the welding tools is changed as a function of this. When the end of the curve is reached, the position of the pedal is then changed again in order to increase the velocity of feed of the drive rollers and to raise the temperature of the welding tools.

The drawback of these prior-art welding machines is, among other things, that the recognition of the beginning of the curve and of the end of the curve is relatively subject to errors and depends, among other things, on the momentary state of mind of the particular person operating the machine.

### SUMMARY OF THE INVENTION

The basic object of the present invention is therefore to provide a plastic welding machine in which the process control of the welding operation is extensively independent from the particular person operating the welding machine.

According to the invention, a plastic welding machine is provided especially a hot air or heating wedge welding machine, for connecting in substance at least two layers. The welding machine contains welding tools with at least one pair of drive rollers, as well as a electronic control device comprising a computer for controlling the temperature of the welding tools and for setting and regulating the pressure of the drive rollers. The electronic control device has at least one memory, into which a process program can be loaded, which controls the welding of the two layers section by section. Primary welding parameters are set. The primary welding parameters are preset by the process program at the beginning of the particular welding section and are characteristic of the given section, such as the temperature of the welding tools or of the particular welding medium, the velocity of feed of the two drive rollers or of one of the two drive rollers, the roller pressing pressure. The welding machine comprises a path measuring system, which is connected to the electronic control device for determining the path section of the layers welded together during the welding operation. The electronic control device is designed such that it performs a comparison between the measured path section of the particular layers welded together and a preset value characterizing the beginning of the next welding section. The electronic control device sets the welding parameter characteristic of the corresponding new welding section in case of agreement between the measured value and the preset value.

The present invention is based essentially on the idea that the process control of the welding operation is performed without the action of a human operator, only by means of a process program (welding program) stored in a memory of the control device. The entire area of the two layers that is to be welded is divided, before the welding operation is performed, into a plurality of welding sections, and the (primary) welding parameters, which are to be complied with, such as the temperature of the welding tools or of the welding medium, the velocity of feed of the two drive rollers or of one of the two drive rollers, the roller contact pressure, etc., are determined for each welding section. The parameters corresponding to these settings are stored in a memory of the control device, to which the process program has access.

During the welding operation proper, the control device of the welding machine will then determine the particular path section already welded by means of a path measuring system and compares these values with a preset value characterizing the beginning of a new welding section. If the preset value is reached, the process program automatically prompts the setting of the welding parameters characteristic of the new welding section.

A total of three welding sections would preferably be set in the example of a curved welding section mentioned in the introduction, and the welding parameters would then be preset such that the drive rollers would be rotating synchronously in the two welding sections extending along a straight line, whereas the welding parameters would be selected in the curved welding section such that the upper roller would be running somewhat faster in order to compensate the extra width of the upper layer.

Consequently, the welding operation takes place essentially without the contribution of a human operator when the welding machine according to the present invention is used. The section lengths of the welding sections are set in advance and then repeated very precisely during each welding operation. The welding machine according to the present invention can therefore be used especially advantageous mainly when identical parts recurring time and time again are manufactured, in which a corresponding number of welding programs with different parameters and path sections must be taken into account and which always take place repeatedly in a sequence for manufacturing, e.g., ten different weld seams. It is thus possible to process a complete batch of a certain size of garment, in which the human operator only needs to insert the material to be welded into the welding machine in a predetermined order, give the start signal and only guide in the correct direction.

It proved to be advantageous if the welding parameters that can be maintained at constant values for the entire welding operation (hereinafter also called secondary welding parameters) are set only at the beginning of the particular welding operation by means of the process program. The secondary welding parameters are essentially parameters that set the setting of the acceleration and deceleration characteristics as well as the length of the start delay for compensating the heating operation of the welding tools (roller parameters) as well as parameters that concern the design of the particular nozzle or wedge (narrow, medium or broad) (welding tool parameters).

Furthermore, it proved to be advantageous if the control device comprises a memory in which data that can be displayed on the display screen of the welding machine can be stored and that show comments associated with the particular current welding program and/or settings of the welding tools (so-called notepad data). These data may be entered, for example, when setting the particular process program in the electronic control device.

To ensure that the notepad data are also heeded and implemented, a release key may also be assigned to the data being displayed, so that the corresponding process program is released only when the particular human operator presses the release key (e.g., a touch field of the display screen).

In a first embodiment of the present invention, the path measuring system of the plastic welding machine comprises at least one tachometer generator.

Further details and advantages of the present invention appear from the following exemplary embodiments explained on the basis of figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 shows the block diagram of a hot air welding machine according to the present invention;

FIG. 2 is a view showing an example of the use of the welding machine according to the present invention;

FIG. 3 is a view showing another example of the use of the welding machine according to the present invention;

FIG. 4 is a view showing another example of the use of the welding machine according to the present invention; and

FIG. 5 is a vie showing an exemplary embodiment of a notepad function displayed on the display screen of the welding machine according to the present invention.

### DESCRIPTION OF THE PREFERRED EMBODIMENT

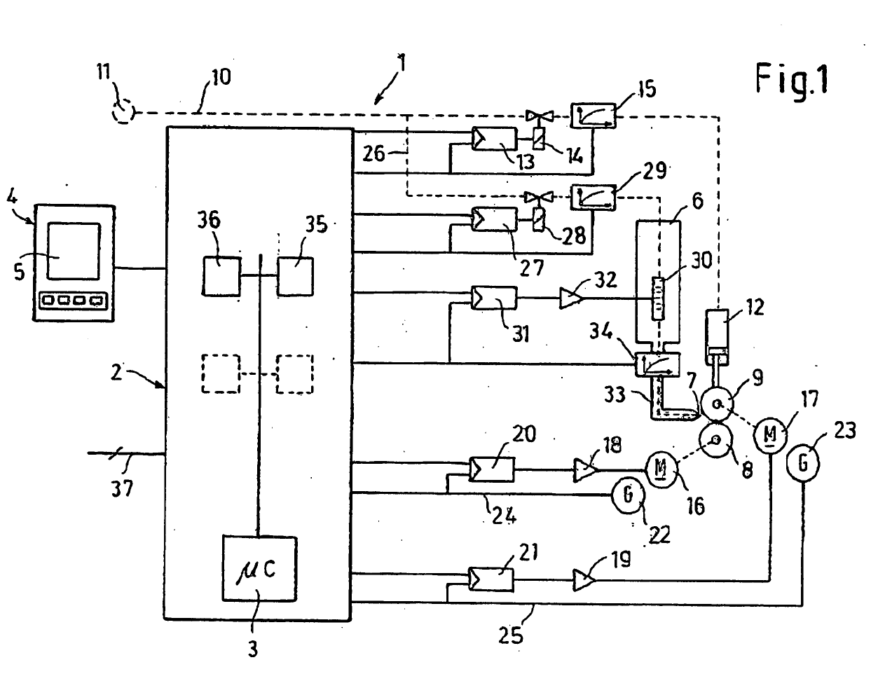

Referring to the drawings in particular, a hot air welding machine, which is shown schematically, is designated by 1 in FIG. 1 (cf DE 198 54 259 C2 mentioned in the introduction for the design and the mode of operation of such welding machines). The welding machine 1 comprises an electronic control device 2, which contains, among other things, a microcomputer 3. The control device 2 is connected to an operating device 4 having a display screen 5.

In addition, the welding machine 1 according to the present invention comprises an air heater 6, which is connected to a hot air nozzle 7, which is directed into the area between the layers (not shown) to be welded together, as well as a roller type pressing system, which comprises two mutually opposite drive rollers 8, 9 for feeding the two layers and a compressed air cylinder 12 connected to a compressed air source 11 via a compressed air line 10.

The compressed air cylinder 12 is operated via a regulator 13, with which a servo valve 14 is associated. The servo valve 14 affects the pressure of the compressed air delivered from the compressed air source 11 via the line 10. A pressure sensor 15, whose signal is sent to the electronic control device 2 and to the regulator 13, is used to determine the actual pressure values.

The two drive rollers 8, 9 are driven via a motor 16, 17 of their own each, which are connected to the electronic control device 2 via a power part 18, 19 each and a respective regulator 20, 21. To determine the driving speed of the particular motor 16, 17, the latter is connected to a tachometer generator 22, 23, whose measured results are likewise sent to the control device 2 via a corresponding line 24, 25.

The air heater 6 is connected to the compressed air source 11 via a compressed air line 10 and a branch line 26. A regulator 27, with which a servo valve 28 is associated as a final control element, is used to regulate the amount of air. A sensor 29, whose signal is sent to the control device 2 and to the regulator 27, is used to determine the actual value of the amount of air fed to the air heater 6.

The air heater 6 comprises an electrically operated heating element 30, which is operated via a regulator 31 connected to the control device 2 and via a power part 32. A sensor 34, which is arranged in the connection pipe 33 leading to the hot air nozzle 7, and which is connected to the control device 2 and to the regulator 31, is used to determine the actual value of the hot air temperature.

The electronic control device 2 also comprises, besides the microcomputer 3, among other things, a program memory 35, in which a process program (welding program) is stored, which controls the entire welding operation of the welding machine 1, as well as a data memory 36, in which the data that can be polled by the process program are stored. Both the data and the process program can be loaded into the control device 2 via an interface and a line 37.

To carry out the welding operation, welding sections with preset length, within which the primary welding parameters, such as the temperature of the hot air, the velocity of feed of the two drive rollers 8, 9, the amount of air and the pressing pressure of the rollers, are to be maintained at constant values, are set beforehand. The microcomputer 3 of the control device 2 then determines during the welding operation the path section traveled by the layers welded together by determining and evaluating the numbers of revolutions of the motors 16, 17, which are measured by means of the tachometer generators 22, 23. As soon as the microcomputer 3 determines by a comparison that the current welding section is ended, the control device 2 prompts the reading of the welding parameters that are characteristic of the corresponding new welding section and are being stored in the memory 36, and the corresponding changes are set.

Besides the primary welding parameters, so-called secondary welding parameters are also stored in the memory 36 or another memory before the welding operation proper. These secondary welding parameters lead to settings of the welding machine 1 that do not change during the entire welding operation. The secondary welding parameters are essentially parameters that set the setting of the acceleration and deceleration characteristics as well as the length of the start delay (for compensating the heating operation of the welding tools) or parameters that concern the size of the hot air nozzle or, in case of a heating wedge welding machine, the size of the wedge, which may be narrow, medium or broad.

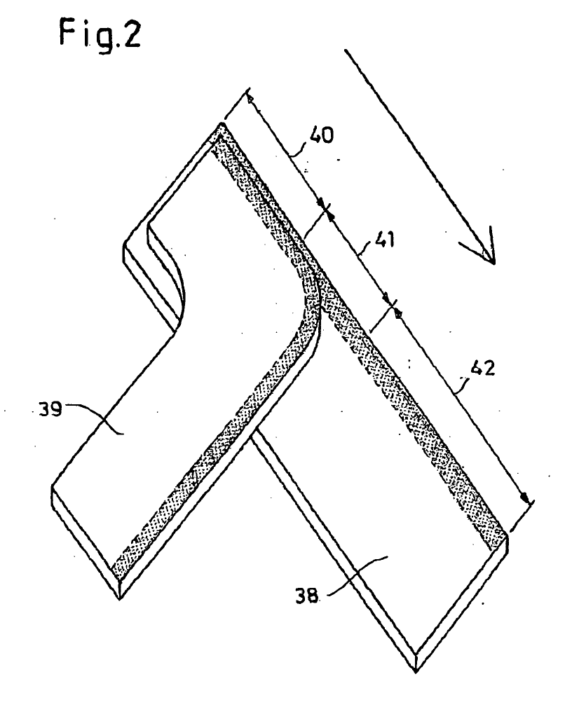

The present invention will be explained in greater detail below by means of three examples shown in FIGS. 2-4.

FIG. 2 shows the welding together of a straight lower layer designated by 38 with a round upper layer 39, which may happen, for example, during the welding on of a sleeve.

Three welding sections 40-42 are set in this case. The motors 16, 17 must be actuated now by the control device such that the drive rollers 8, 9 rotate synchronously in the welding section 40. By contrast, the motors 16, 17 are actuated in the welding section 41 such that the upper drive roller 9 rotates somewhat faster than the lower drive roller 8 in order to compensate the extra width of the upper layer 39. The two drive rollers 8, 9 must, by contrast, rotate synchronously in the welding section 42.

The switchover between the individual welding sections 40-42 is preprogrammed section by section. During welding in the second welding section 42, the upper layer 39 is “turned in” by the corresponding human operator under the lower layer 38 with equal edge.

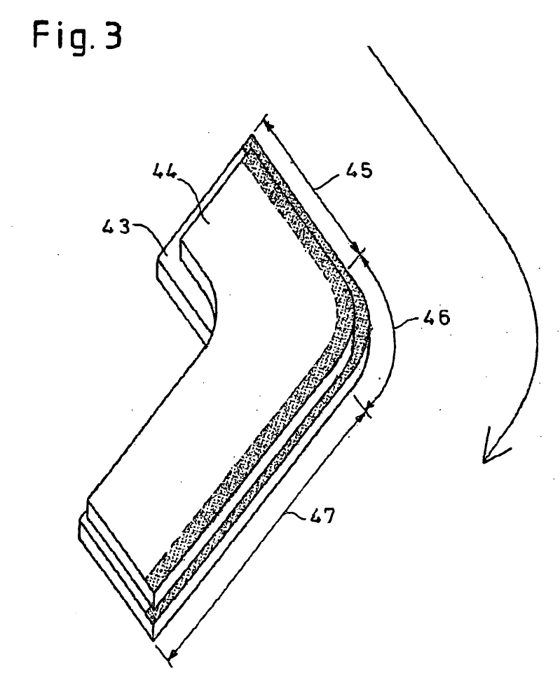

FIG. 3 shows the welding together of two layers 43, 44, both of which are provided with a rounding. Three welding sections 45-47 are defined in this case as well. Welding can be performed rapidly now in welding section 45 (straight piece), i.e., the motors 16, 17 can bring about a high speed of rotation of the drive rollers 8, 9 and the temperature of the hot air can be relatively high. Welding must be performed more slowly in welding section 46 (area of the rounding) mainly for reasons of handling, so that the speed of rotation of the drive rollers 8, 9 must be slower and the temperature of the hot air must be lower. What was said in connection with welding section 45 applies analogously to the welding section 47 (straight piece).

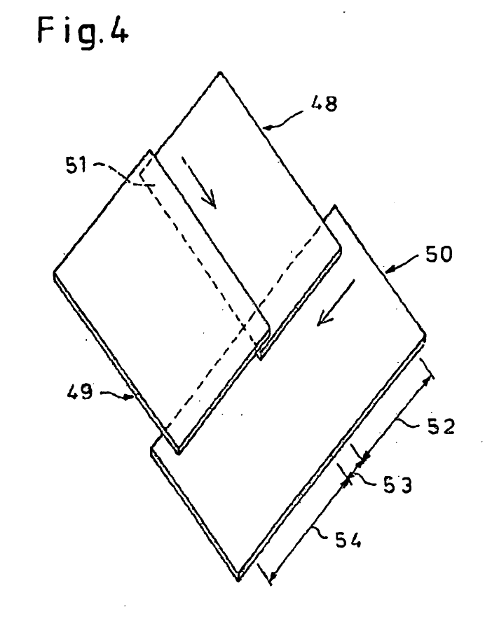

Three layers 48-50 are welded together in the exemplary embodiment shown in FIG. 4. The layer 48 is welded to layer 49 in a first operation, so that a weld seam 51 is obtained. The layer 50 is then connected to the layer consisting of the layers 48 and 49 in a second operation. Three welding sections 52-54 are again defined now. A so-called T-joint is obtained here due to the weld seam 51 in the welding section 53. It is proper to work with somewhat hotter air or with a different roller pressure in this welding section.

The present invention is not, of course, limited to the exemplary embodiments described. Thus, another prior-art path sensor may also be used instead of a tachometer generator for the measurement of the welding sections.

In particular, it may be useful to set the individual welding sections by providing the material to be welded with marks that are scanned by a sensor.

The statements made in connection with the above-described hot air welding machine also apply analogously to a heating wedge welding machine. Essentially only the hot air system is replaced with a heating wedge system. By contrast, a path measuring system as well as a roller pressing system with different actuation of the drive rollers must be present for the process control according to the present invention in such welding machines as well.

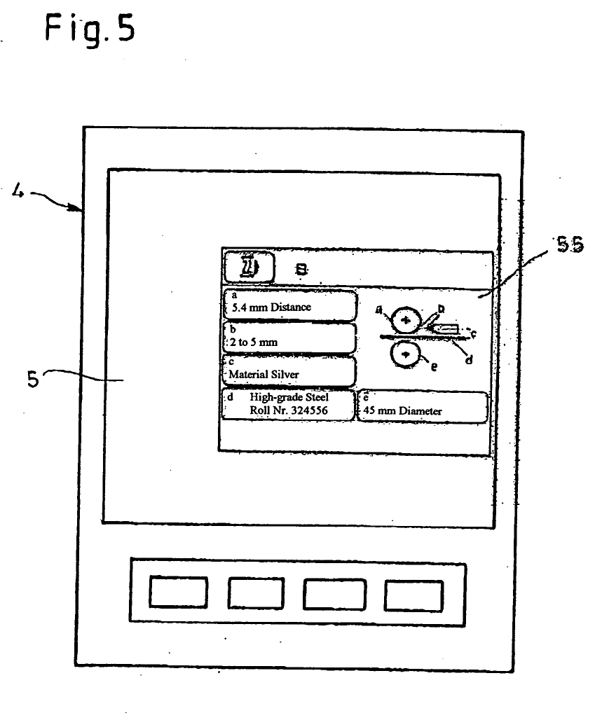

In addition, it proved to be useful if data that can be displayed on the display screen 5 of the welding machine and that show the comments and/or settings of the welding tools that are associated with the particular current welding program can be stored either in the memory 5 of the control device 2 or in another memory. A corresponding view is shown in FIG. 5.

The display screen of the operating device 4 is again designated by 5 and a view displayed on the display screen 5, which shows the arrangement of the heating wedge (in case of a heating wedge welding machine) in relation to the drive rollers, is designated by 55. The letters a-e shown in the view are explained in greater detail to the human operator in the boxed fields. These fields may also be designed as touch fields, so that the machine is released only when, e.g., all fields have been pressed.

While specific embodiments of the invention have been shown and described in detail to illustrate the application of the principles of the invention, it will be understood that the invention may be embodied otherwise without departing from such principles.

1. A plastic welding machine for connecting in substance at least two plastic layers, the welding machine comprising:
a welding tool,
drive rollers,
an electronic control device comprising a computer for controlling the temperature of the welding tool and for setting and regulating the pressure of the drive rollers, wherein:
a) the electronic control device has at least one memory, into which a process program can be loaded, which controls the welding of the two layers section by section, wherein primary welding parameters, which are preset by the process program at the beginning of the particular welding section and are characteristic of the given section, said welding parameters including at least one of temperature of the welding tool or of the particular welding medium, the velocity of feed of the two drive rollers or of one of the two drive rollers, the roller pressing pressure, are set;
b) the welding machine comprises a path measuring system, which is connected to the electronic control device for determining the path section of the layers welded together during the welding operation; and
c) the electronic control device performs a comparison between the measured path section of the particular layers welded together and a preset value characterizing the beginning of the next welding section and sets the welding parameter characteristic of the corresponding new welding section in case of agreement between the measured value and the preset value.

2. A plastic welding machine in accordance with claim 1, wherein the path measuring system comprises at least one tachometer generator.

3. A plastic welding machine in accordance with claim 1, wherein a sensor, which scans said marks that define the individual welding sections and are arranged on the material to be welded, is provided as the distance measuring system.

4. A plastic welding machine in accordance with claim 1, wherein the two drive rollers can be driven at different speeds of rotation.

5. A plastic welding machine in accordance with claim 1, that wherein the control device comprises a memory, in which data that can be displayed on a display screen of the welding machine and show comments and/or settings of the welding tool that are associated with the particular current welding program can be stored.

6. A plastic welding machine in accordance with claim 5, wherein the control device comprises a memory, which contains secondary roller and welding tool parameters, which can be set by the process program before the start of the welding operation and remain effective for the entire welding operation comprising a plurality of said welding sections.
